(19) United States
(12) Patent Application Publication
(10) Pub. No.: US 2026/0099532 A1
(43) Pub. Date: Apr. 9, 2026

(54) SYSTEMS AND METHODS FOR RESOLVING LARGE TAXONOMY SELECTION

(71) Applicant: Elsevier, Inc., New York, NY (US)

(72) Inventors: Seyedamin Tabatabaei, Amstelveen (NL); Georgios Tsatsaronis, Zwanenburg (GR); Michael Parsons, London (GB); Georgia Hellard Timm, London (GB); Sarah Fancher, Nixa, MO (US); Gregory J. Gordon, Rochester, NY (US)

(73) Assignee: Elsevier, Inc., New York, NY (US)

(21) Appl. No.: 19/349,038

(22) Filed: Oct. 3, 2025

Related U.S. Application Data
(60) Provisional application No. 63/703,290, filed on Oct. 4, 2024.

(51) Int. Cl. G06F 16/35; G06F 16/31

(52) U.S. Cl. CPC G06F 16/35; G06F 16/322

(57) ABSTRACT

A method for classifying a document into a hierarchical taxonomy associated with a corpus of documents, the document being associated with document information, the hierarchical taxonomy comprising a plurality of levels with each level comprising one or more nodes, each node comprising a label; the method may include inputting the taxonomy and the document information into a large language model, inputting a prompt into the large language model to cause the large language model to output one or more nodes of the taxonomy for classifying the document based on the document information, and classifying the document into each of the nodes output by the large language model.

### CROSS REFERENCE TO RELATED APPLICATION

This application claims priority to U.S. Provisional Application No. 63/703,290, filed Oct. 4, 2024, the entire contents of which is hereby incorporated by reference.

### FIELD

The present disclosure generally relates to taxonomy selection, and more particularly, to systems and methods for resolving large taxonomy selection.

### BACKGROUND

Searchable databases of documents are often arranged based on a taxonomy such that the database can be more easily searched. In particular, a hierarchical taxonomy may include a plurality of nodes, with each node having a label comprising a category. Each document may be classified within a particular node or category. To assist researchers in finding relevant documents, a hierarchical taxonomy may be developed. That is, a highest level of a taxonomy may include a plurality of nodes having broad categories, a lower level of the taxonomy may include a plurality of nodes having narrow categories, and this may continue down to the leaf nodes which have the narrowest categories. This may allow documents having a certain subject matter to be more easily found by traversing the various categories of the taxonomy.

When a new document is to be added to a database, it may be classified as belonging to one or more leaf nodes. One way to classify new documents added to a database is to have human subject matter experts review the documents and determine which labels of the taxonomy should be applied. However, this may be overly time consuming. In addition, there may be a subjective nature to label assignment which may cause subject matter experts to make less than ideal label assignments when adding new documents to a database taxonomy. Accordingly, a need exists for systems and methods for resolving large taxonomy selection.

### SUMMARY

In one embodiment, a method is presented for classifying a document into a hierarchical taxonomy associated with a corpus of documents. The document may be associated with document information. The hierarchical taxonomy may include a plurality of levels with each level comprising one or more nodes. Each node of the taxonomy may include a label. The method may include inputting the taxonomy and the document information into a large language model, inputting a prompt into the large language model to cause the large language model to output one or more nodes of the taxonomy for classifying the document based on the document information, and classifying the document into each of the nodes output by the large language model.

In another embodiment, a system is presented for classifying a document into a hierarchical taxonomy associated with a corpus of documents. The document may be associated with document information. The hierarchical taxonomy may include a plurality of levels with each level including one or more nodes. Each node may include a label. The system may include one or more processors and a non-transitory, processor-readable storage medium include one or more programming instructions stored thereon. When executed, the programming instructions may cause the one or more processors to input the taxonomy and the document information into a large language model, input a prompt into the large language model to cause the large language model to output one or more nodes of the taxonomy for classifying the document based on the document information, and classify the document into each of the nodes output by the large language model.

These and other features and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular forms of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, wherein like structure is indicated with like reference numerals and in which:

FIG. 1 schematically depicts an illustrative computing network for a system for resolving large taxonomy selection, according to one or more embodiments shown and described herein;

FIG. 2 schematically depicts the server computing device from FIG. 1, further illustrating hardware and software that may be used in resolving large taxonomy selection, according to one or more embodiments shown and described herein;

FIG. 3 depicts a flow diagram of an example method of resolving large taxonomy selection, according to one or more embodiments shown and described herein;

FIG. 4 depicts a flow diagram of another example method of resolving large taxonomy selection, according to one or more embodiments shown and described herein;

FIG. 5 depicts a flow diagram of another example method of resolving large taxonomy selection, according to one or more embodiments shown and described herein; and

FIG. 6 depicts a flow diagram of another example method of resolving large taxonomy selection, according to one or more embodiments shown and described herein.

### DETAILED DESCRIPTION

Referring generally to the figures, embodiments described herein are directed to systems and methods for resolving large taxonomy selection. In embodiments, a database includes a plurality of documents and a taxonomy structure. The taxonomy structure is a hierarchical tree with nodes representing different categories (e.g., scientific disciplines). Each node is defined by a label, an ID, and relationship with parent and child nodes. Some of the nodes may also have a brief description that describes the type of documents associated with that node (e.g., the type of research applicable to that specific node). The taxonomy may be dynamic and may be periodically updated by subject matter experts to reflect ongoing developments. This process may involve adding, removing, or merging nodes to ensure that the taxonomy remains up to date. Each document of a database may be assigned to one or more leaf nodes (e.g., the lowest level of nodes among the taxonomy).

When a new document is to be added to the database, it may be automatically classified within one leaf node of the taxonomy using the techniques described herein. In embodiments, when a document is to be classified within the taxonomy, a title, an abstract, and one or more keywords associated with the document may be received. Each node of the taxonomy may comprise a label, an ID, a relationship with parent and child nodes, and optionally a description.

When a document is to be classified, the taxonomy may be initially filtered using a bi-encoder. In particular, a cosine similarity may be calculated between the document to be classified and each leaf node of the taxonomy. A pruned taxonomy is then generated that includes only the leaf nodes having the highest cosine similarities (e.g., the top 40 leaf nodes) along with their parent nodes. A large language model (LLM) is then used to select the leaf nodes from the pruned taxonomy that are most appropriate for the document to be classified, using a variety of techniques disclosed herein. The document is then classified into one or more of the leaf nodes determined by the LLM.

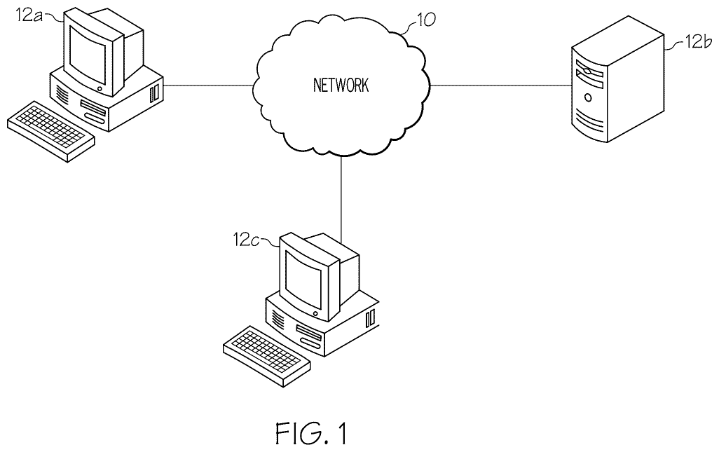

Referring now to the drawings, FIG. 1 depicts an illustrative computing network, illustrating components of a system for performing the functions described herein, according to embodiments shown and described herein. As illustrated in FIG. 1, a computer network 10 may include a wide area network, such as the internet, a local area network (LAN), a mobile communications network, a public service telephone network (PSTN), and/or other network and may be configured to electronically connect a user computing device 12a, a server computing device 12b, and an administrator computing device 12c.

The user computing device 12a may be used to input information from a user and display information to the user. The user computing device 12a may also be utilized to perform other user functions.

The administrator computing device 12c may, among other things, perform administrative functions for the server computing device 12b. In the event that the server computing device 12b requires oversight, updating, or correction, the administrator computing device 12c may be configured to provide the desired oversight, updating, and/or correction. The administrator computing device 12c, as well as any other computing device coupled to the computer network 10, may be used to input one or more documents into the document database.

The server computing device 12b may receive instructions from the user computing device 12a to categorize a document into a taxonomy. The server computing device 12b may also transmit information about the document categorization to the user computing device 12a. The components and functionality of the server computing device 12b will be set forth in detail below.

It should be understood that while the user computing device 12a and the administrator computing device 12c are depicted as personal computers and the server computing device 12b is depicted as a server, these are non-limiting examples. More specifically, in some embodiments any type of computing device (e.g., mobile computing device, personal computer, server, etc.) may be utilized for any of these components. Additionally, while each of these computing devices is illustrated in FIG. 1 as a single piece of hardware, this is also merely an example. More specifically, each of the user computing device 12a, the server computing device 12b, and the administrator computing device 12c may represent a plurality of computers, servers, databases, etc.

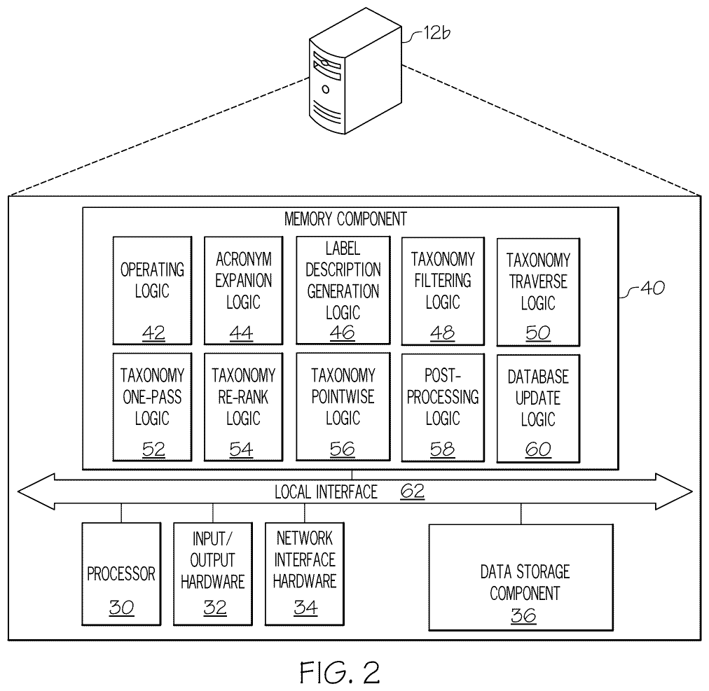

FIG. 2 depicts additional details regarding the server computing device 12b from FIG. 1. While in some embodiments, the server computing device 12b may be configured as a general purpose computer with the requisite hardware, software, and/or firmware, in some embodiments, that server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36, and a non-transitory memory component 40. The memory component 40 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store operating logic 42, acronym expansion logic 44, label description generation logic 46, taxonomy filtering logic 48, taxonomy traverse logic 50, taxonomy one-pass logic 52, taxonomy re-rank logic 54, taxonomy pointwise logic 56, post-processing logic 58, and database update logic 60 (each of which may be embodied as a computer program, firmware, or hardware, as an example). A local interface 62 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components (e.g., data associated with a taxonomy, and model parameters, as discussed below). In particular, the data storage component 36 may store documents and taxonomy information, including which categories of the taxonomy each document is associated with. The data storage component 36 may also store an LLM to be used to classify documents, as disclosed herein. Other data may be stored in the data storage component 36 to provide support for functionalities described herein.

Included in the memory component 40 are the operating logic 42, the acronym expansion logic 44, the label description generation logic 46, the taxonomy filtering logic 48, the taxonomy traverse logic 50, the taxonomy one-pass logic 52, the taxonomy re-rank logic 54, the taxonomy pointwise logic 56, the post-processing logic 58, and the database update logic 60. The operating logic 42 may include an operating system and/or other software for managing components of the server computing device 12b. The functionalities of the acronym expansion logic 44, the label description generation logic 46, the taxonomy filtering logic 48, the taxonomy traverse logic 50, the taxonomy one-pass logic 52, the taxonomy re-rank logic 54, the taxonomy pointwise logic 56, the post-processing logic 58, and the database update logic 60 will be described in further detail below.

It should be understood that the components illustrated in FIG. 2 are merely illustrative and are not intended to limit the scope of this disclosure. More specifically, while the components in FIG. 2 are illustrated as residing within the server computing device 12b, this is a non-limiting example. In some embodiments, one or more of the components may reside external to the server computing device 12b. Similarly, while FIG. 2 is directed to the server computing device 12b, other components such as the user computing device 12a and the administrator computing device 12c may include similar hardware, software, and/or firmware.

The acronym expansion logic 44 may expand any acronyms contained in node labels of the taxonomy. Many node labels contain acronyms, which may be difficult for the LLM to comprehend. For example, the label “FoodSciRN Conferences & Meetings” refers to “Food Science Research Network”. The latter is easier for the LLM to understand than the former. As such, the acronym expansion logic 44 may parse through the label of each node, identify any acronyms contained thereon, and expand the identified acronyms into the full name thereof. This may improve the performance of the LLM when categorizing documents into the taxonomy, as discussed in further detail below.

The label description generation logic 46 may determine descriptions for labels of nodes in the taxonomy, as disclosed herein. As discussed above, each node in the taxonomy comprises a label, an ID, and a relationship with parent and child nodes. In addition, some nodes may also contain a description. However, not all labels contain a description. The classification techniques for categorizing a document described herein may perform better when a category label includes a description. However, manually creating descriptions for a large taxonomy by subject matter experts may be overly burdensome and time consuming. Accordingly, in embodiments, the label description generation logic 46 may automatically generate descriptions for category labels, as disclosed herein.

In embodiments, the label description generation logic 46 may use an LLM to generate a description for a category label. In particular, to generate a description for a particular node, the label description generation logic 46 may input the label name of the node and the label name of the parent node into an LLM. If the parent node has a description, the label description generation logic 46 may also input the description of the parent node into the LLM. The label description generation logic 46 may then ask the LLM to generate a label description based on the label name of the node, the label name of the parent node, and the description of the parent node if it is available. The descriptions generated by the label description generation logic 46 may be used to classify documents, as discussed in further detail below.

In embodiments, a document may be classified into a taxonomy using four different techniques, as disclosed herein. The first technique utilizes the full taxonomy, whereas the other three techniques utilize a bi-encoder model to provide an initial filtering of the taxonomy to generate a pruned taxonomy. The pruned taxonomy is then used in the other three techniques to classify a document. Each of these techniques is discussed in turn below.

As discussed above, each document to be classified comprises a title, an abstract, and one or more keywords associated with the document, in addition to the full text of the document. In the illustrated example, a document is classified based on the title, the abstract, and the keywords, rather than the full text of the document. This allows the LLM to process a smaller amount of data than would be required if the full text of the document were analyzed. However, in other examples, the full document text may be analyzed by the LLM to classify a document.

The first technique for classifying a document into a taxonomy may be performed by the taxonomy traverse logic 50. This technique comprises prompting the LLM to traverse the taxonomy layer by layer using a breadth-first search strategy, as disclosed herein. In particular, the LLM is first prompted to evaluate top-level nodes of the taxonomy to identify relevant categories based on document information for a particular document to be classified (e.g., title, abstract, and keywords). That is, the LLM makes a binary decision for each top-level node as to whether or not the node is relevant to the document.

Each node selected by the LLM as being relevant to the document can either be a leaf node (i.e., a node without children), or a parent node. For each leaf node determined to be relevant to the document by the LLM, the leaf node is added to a set of selected nodes from the taxonomy. For each parent node determined to be relevant to the document by the LLM, the taxonomy traverse logic 50 instructs the LLM to determine whether each child node of each selected parent node is relevant to the document based on the document information. This process is continued until the entire taxonomy has been traversed and each leaf node of the taxonomy is identified as either relevant or not relevant to the document. In some examples, the document may then be classified into each of the leaf nodes selected as relevant. In other examples, the selected leaf nodes may be subject to post-processing, as discussed in further detail below.

Referring still to FIG. 2, the taxonomy filtering logic 48 is used for the other three disclosed techniques for classifying a document into a taxonomy. For these techniques, inputting the entire taxonomy into the LLM for analysis may be overly burdensome on the resources of the LLM. Accordingly, in embodiments, the taxonomy filtering logic 48 may filter the taxonomy as disclosed herein.

In particular, when a document is to be classified into the taxonomy, the taxonomy filtering logic 48 may determine a first embedding or vectorization of the document information (e.g., title, abstract, and keywords) and a second embedding or vectorization of the label and description of each leaf node of the taxonomy using a bi-encoder model. The taxonomy filtering logic 48 may then determine, using the bi-encoder model, a cosine similarity between the first embedding of the document information and the second embedding of the label and description of each leaf node. As such, the determined cosine similarity values will indicate a similarity between the document and each leaf node of the taxonomy. In some examples, similarity metrics other than cosine similarity may be used.

After a cosine similarity between the document and each leaf node of the taxonomy is determined, some number of nodes may be removed from the taxonomy to generate a pruned taxonomy, as disclosed herein. In some examples, a threshold cosine similarity value may be determined (e.g., 0.8), and all leaf nodes having a cosine similarity below the threshold value may be removed. In other examples, a predetermined number of leaf nodes may be kept (e.g., the 40 leaf nodes having the highest cosine similarity), and the remaining leaf nodes may be removed.

After some number of leaf nodes are removed from the taxonomy using one of the techniques described above, all parent nodes in the taxonomy that do not have a descendent leaf node remaining in the taxonomy are also removed. The remaining nodes define a pruned taxonomy, which may be used to classify documents using the three techniques disclosed below. By removing nodes having a low similarity to the document, the pruned taxonomy has removed nodes that are irrelevant to the document being classified. This will reduce the computational load of subsequent steps in the document classification techniques described below.

A second technique for classifying a document into a taxonomy may be performed by the taxonomy one-pass logic 52, as disclosed herein. This technique is a one-pass approach in which the LLM is tasked with simultaneously classifying all potential labels in a single prompt, as disclosed herein. In particular, the taxonomy one-pass logic 52 inputs the pruned taxonomy, including the label and description of each node, and the document information into the LLM along with a prompt asking the LLM to select nodes having the most relevant labels from the pruned taxonomy. In some examples, the prompt instructs the LLM to identify a node as relevant if its label is relevant to the document, and the labels of all of its parent and ancestor nodes are relevant to the document. The labels selected by the LLM are then used to classify the document.

A third technique for classifying a document into a taxonomy may be performed by the taxonomy re-rank logic 54, as disclosed herein. This technique generates a relevancy score for each node in the pruned taxonomy in relation to the document and then re-ranks the leaf nodes based on the relevancy scores, as disclosed herein. In particular, the taxonomy re-rank logic 54 first prompts the LLM to assign a relevancy score to each node (including parent nodes and leaf nodes) in the pruned taxonomy based on a similarity between the label and description of each node and the document information. The taxonomy re-rank logic 54 then ranks the leaf nodes of the pruned taxonomy based on the determined similarity scores, as disclosed herein.

In a first example, the taxonomy re-rank logic 54 ranks each leaf node simply based on the relevancy score of each leaf node. In a second example, the taxonomy re-rank logic 54 ranks each leaf node based on an average of the relevancy score of the leaf node and the relevancy score of its direct parent node. In a third example, the taxonomy re-rank logic 54 ranks each leaf node based on an average of the relevancy score of the leaf node and relevancy scores of all of its ancestor nodes. In a fourth example, the taxonomy re-rank logic 54 ranks each leaf node based on a harmonic mean of the relevancy score of the leaf node and the relevancy scores of all of its ancestor nodes. After the leaf nodes of the pruned taxonomy are ranked using one of the above-described techniques, the taxonomy re-rank logic 54 may select a predetermined number of the most highly ranked leaf nodes (e.g., the 5 highest-ranked leaf nodes).

A fourth technique for classifying a document into a taxonomy is performed by the taxonomy pointwise logic 56, as disclosed herein. This technique follows a pointwise classification approach, breaking down the classification task into a series of independent binary classification decisions. In particular, the taxonomy pointwise logic 56 inputs the pruned taxonomy and the document information into the LLM, along with a prompt asking the LLM whether each leaf node of the pruned taxonomy is relevant to the document based on the name and description of the leaf node and the document information. Each node is evaluated by the LLM on its own without influence from other nodes. The LLM may then output one or more leaf nodes of the pruned taxonomy that are determined to be relevant to the document.

For each leaf node determined by the LLM to be relevant, the taxonomy pointwise logic 56 then inputs a prompt into the LLM asking the LLM whether the parent node of the leaf node is relevant to the document based on the name and description of the leaf node and the document information. The taxonomy pointwise logic 56 may select a leaf node as an appropriate classification of the document if the LLM identified both the leaf node and its parent node as relevant to the document. In some examples, the taxonomy pointwise logic 56 inputs a single prompt to perform the operations described above, rather than multiple prompts.

Referring still to FIG. 2, the post-processing logic 58 may perform post-processing on the labels selected by any of the taxonomy traverse logic 50, the taxonomy one-pass logic 52, the taxonomy re-rank logic 54, and the taxonomy pointwise logic 56. Each of the four techniques discussed above may classify a document into a plurality of nodes. However, a smaller number of nodes may be desired for a document classification. Accordingly, the post-processing logic 58 may reduce the number of nodes for which a document is classified, as disclosed herein.

In one example, a maximum number of nodes for which a document is to be classified may be determined (e.g., 5 nodes). In some examples, this maximum number may be predetermined. In other examples, this maximum number may be specified by a user. The post-processing logic 58 may then input a prompt to the LLM with the labels and descriptions of all of the leaf nodes selected using one of the techniques described above, along with the labels and descriptions of each parent node of the selected leaf nodes. The prompt may ask the LLM to select the most relevant leaf nodes up to the predetermined maximum number (e.g., the 5 most relevant leaf nodes). The labels of the leaf nodes selected by the LLM in response to this prompt may be used as the final labels to classify the document into the taxonomy.

In another example, there may be multiple sibling nodes selected for classifying a document. That is, multiple nodes may be selected for a document that each have the same parent node. This may be undesirable, and it may be desirable to have no more than one leaf node selected for each parent node. As such, in this example, the post-processing logic 58 may input a prompt into the LLM including multiple labels for previously selected leaf nodes having the same parent node. The prompt may ask the LLM to select the most relevant leaf node among the input sibling nodes for the document. The leaf nodes selected by the LLM may be used as the final labels to classify the document. This may limit the document to being classified into no more than one node sharing a parent node with any other node.

Referring still to FIG. 2, the database update logic 60 may update the database in the data storage component 36 to classify the document into the selected categories. In particular, for each leaf node output by the post-processing logic 58, using the techniques described above, as being most relevant to the document, the document may be classified with the label for that leaf node. In particular, the database update logic 60 may associate the document with each of the leaf nodes output by the post-processing logic 58 in the data storage component 36. Accordingly, the document may be classified into one or more nodes of the taxonomy having the most appropriate labels based on the content of the document.

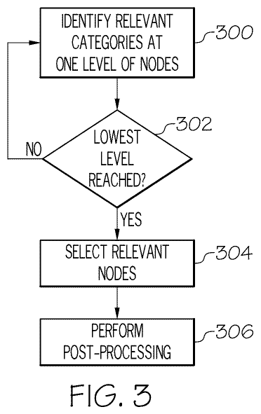

Turning now to FIG. 3, a flowchart is shown of an example method that may be performed by the server computing device 12b to classify a document into a taxonomy. In particular, the example method of FIG. 3 may be performed by the taxonomy traverse logic 50 to perform the first technique for classifying a document into a taxonomy, as discussed above. Although the steps associated with the blocks of FIG. 3 will be described as being separate tasks, in other embodiments, the blocks may be combined or omitted. Further, while the steps associated with the blocks of FIG. 3 will be described as being performed in a particular order, in other embodiments, the steps may be performed in a different order.

At step 300, the taxonomy traverse logic 50 inputs the taxonomy and the document information (e.g., title, abstract, and one or more keywords) into the LLM, along with a prompt to cause the LLM to identify top-level nodes of the taxonomy having labels that are relevant to the document based on the document information. At step 302, the taxonomy traverse logic 50 determines whether the lowest level of the taxonomy has been reached. If the lowest level has not been reached (NO at step 302), control returns to step 300, and the next lower level of the taxonomy is considered. In particular, for each parent node identified as relevant, child nodes are considered and determined whether or not they are relevant. If the lowest level has been reached, control passes to step 304.

At step 304, the taxonomy traverse logic 50 selects each of the leaf nodes of the taxonomy identified as being relevant. At step 306, the post-processing logic 58 performs post-processing on the selected leaf nodes, as discussed above. In particular, the post-processing logic 58 may select the most relevant predetermined number of selected leaf nodes and/or remove multiple sibling nodes form the selected leaf nodes. The database update logic 60 may then update the database maintained by the data storage component 36 to classify the document into the leaf nodes identified by the post-processing logic 58.

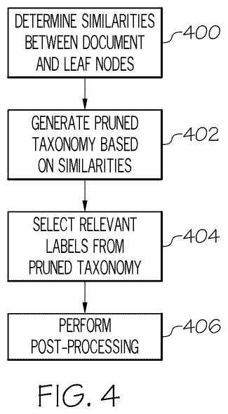

Turning now to FIG. 4, a flowchart is shown of another example method that may be performed by the server computing device 12b to classify a document into a taxonomy. In particular, the example method of FIG. 4 may be performed by the taxonomy one-pass logic 52 to perform the second technique for classifying a document into a taxonomy, as discussed above. Although the steps associated with the blocks of FIG. 4 will be described as being separate tasks, in other embodiments, the blocks may be combined or omitted. Further, while the steps associated with the blocks of FIG. 4 will be described as being performed in a particular order, in other embodiments, the steps may be performed in a different order.

At step 400, the taxonomy filtering logic 48 determines similarities between the document and leaf nodes of the taxonomy, as discussed above. In particular, the taxonomy filtering logic 48 may determine a cosine similarity between an embedding of the document information and embeddings of the leaf nodes (e.g., the label and description of the leaf node). At step 402, taxonomy filtering logic 48 generates a pruned taxonomy based on the determined similarities, as discussed above. For example, the taxonomy filtering logic 48 may select a predetermined number of leaf nodes with the greatest similarity to include in the pruned taxonomy or only include leaf nodes having a similarity above a predetermined threshold.

At step 404, the taxonomy one-pass logic 52 inputs the pruned taxonomy and the document information into the large language model, along with a prompt to cause the large language model to identify leaf nodes of the taxonomy that are relevant to the document based on the document information. At step 406, the post-processing logic 58 performs post-processing logic on the selected leaf nodes, as discussed above. In particular, the post-processing logic 58 may select the most relevant predetermined number of selected leaf nodes and/or remove multiple sibling nodes from the selected leaf nodes. The database update logic 60 may then update the database maintained by the data storage component 36 to classify the document into the leaf nodes identified by the post-processing logic 58.

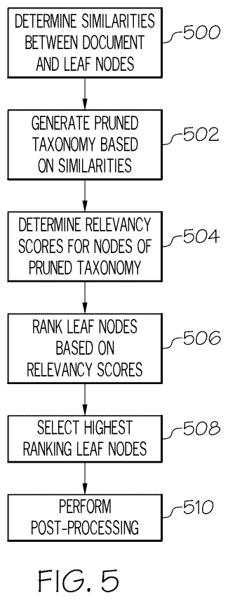

Turning now to FIG. 5, a flowchart is shown of another example method that may be performed by the server computing device 12b to classify a document into a taxonomy. In particular, the example method of FIG. 5 may be performed by the taxonomy re-rank logic 54 to perform the third technique for classifying a document into a taxonomy, as discussed above. Although the steps associated with the blocks of FIG. 5 will be described as being separate tasks, in other embodiments, the blocks may be combined or omitted. Further, while the steps associated with the blocks of FIG. 5 will be described as being performed in a particular order, in other embodiments, the steps may be performed in a different order.

At step 500, the taxonomy filtering logic 48 determines similarities between the document and leaf nodes of the taxonomy, as discussed above. In particular, the taxonomy filtering logic 48 may determine a cosine similarity between an embedding of the document information and embeddings of the leaf nodes (e.g., the label and description of the leaf node). At step 502, the taxonomy filtering logic 48 generates a pruned taxonomy based on the determined similarities, as discussed above. For example, the taxonomy filtering logic 48 may select a predetermined number of leaf nodes with the greatest similarity to include in the pruned taxonomy or only include leaf nodes having a similarity above a predetermined threshold.

At step 504, the taxonomy re-rank logic 54 inputs the pruned taxonomy and the document information into the large language model, along with a prompt to cause the large language model to determine relevancy scores for the nodes of the pruned taxonomy based on the document information. At step 506. the taxonomy re-rank logic 54 ranks the leaf nodes of the pruned taxonomy based on the determined relevancy scores. At step 508, the taxonomy re-rank logic 54 selects a predetermined number of the leaf nodes having the highest ranking.

At step 510, the post-processing logic 58 performs post-processing logic on the selected leaf nodes, as discussed above. In particular, the post-processing logic 58 may select the most relevant predetermined number of selected leaf nodes and/or remove multiple sibling nodes form the selected leaf nodes. The database update logic 60 may then update the database maintained by the data storage component 36 to classify the document into the leaf nodes identified by the post-processing logic 58.

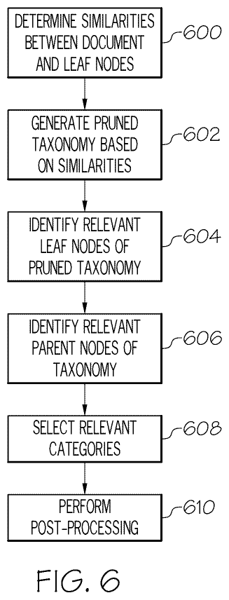

Turning now to FIG. 6, a flowchart is shown of another example method that may be performed by the server computing device 12b to classify a document into a taxonomy. In particular, the example method of FIG. 6 may be performed by the taxonomy pointwise logic 56 to perform the fourth technique for classifying a document into a taxonomy, as discussed above. Although the steps associated with the blocks of FIG. 6 will be described as being separate tasks, in other embodiments, the blocks may be combined or omitted. Further, while the steps associated with the blocks of FIG. 6 will be described as being performed in a particular order, in other embodiments, the steps may be performed in a different order.

At step 600, the taxonomy filtering logic 48 determines similarities between the document and leaf nodes of the taxonomy, as discussed above. In particular, the taxonomy filtering logic 48 may determine a cosine similarity between an embedding of the document information and embeddings of the leaf nodes (e.g., the label and description of the leaf node). At step 602, the taxonomy filtering logic 48 generates a pruned taxonomy based on the determined similarities, as discussed above. For example, the taxonomy filtering logic 48 may select a predetermined number of leaf nodes with the greatest similarity to include in the pruned taxonomy or only include leaf nodes having a similarity above a predetermined threshold.

At step 604, the taxonomy pointwise logic 56 inputs the pruned taxonomy and the document information into the large language model, along with a prompt to cause the large language model to identify leaf nodes of the taxonomy that are relevant to the document based on the document information. At step 606, the taxonomy pointwise logic 56 causes the large language model to identify relevant parent nodes of the taxonomy among leaf nodes identified as relevant. In some examples, the taxonomy pointwise logic 56 may input a second prompt to the large language model to identify the relevant parent nodes in step 606. In other examples, the prompt input to the large language model in step 604 may cause the large language model to identify relevant leaf nodes that also have relevant parent nodes. At step 608, the taxonomy pointwise logic 56 selects leaf nodes as relevant if the leaf node and its parent node are identified as relevant.

At step 610, the post-processing logic 58 performs post-processing logic on the selected leaf nodes, as discussed above. In particular, the post-processing logic 58 may select the most relevant predetermined number of selected leaf nodes and/or remove multiple sibling nodes form the selected leaf nodes. The database update logic 60 may then update the database maintained by the data storage component 36 to classify the document into the leaf nodes identified by the post-processing logic 58.

It should now be understood that embodiments disclosed herein are directed to systems and methods for resolving large taxonomy selection. By utilizing a large language model as disclosed herein, a system can automatically classify a document being added to a corpus without human intervention. As such, documents can be quickly and efficiently added to and classified in the corpus. If the taxonomy of the corpus changes, documents in the corpus can be automatically reclassified as necessary using the techniques described herein.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for classifying a document into a hierarchical taxonomy associated with a corpus of documents, the document being associated with document information, the hierarchical taxonomy comprising a plurality of levels with each level comprising one or more nodes, each node comprising a label, the method comprising:
inputting the taxonomy and the document information into a large language model;
inputting a prompt into the large language model to cause the large language model to output one or more nodes of the taxonomy for classifying the document based on the document information; and
classifying the document into each of the nodes output by the large language model.

2. The method of claim 1, wherein each node comprises a description.

3. The method of claim 1, further comprising:
prior to inputting the taxonomy and the document information into the large language model, causing the large language model to generate a description for each node of the taxonomy based on the label of the node and a label of its parent node.

4. The method of claim 1, further comprising:
prior to inputting the taxonomy and the document information into the large language model, expanding acronyms of the labels of the nodes in the taxonomy.

5. The method of claim 1, wherein the document information comprises a title, an abstract, and one or more keywords.

6. The method of claim 1, wherein:
the prompt causes the large language model to traverse top-level nodes of the taxonomy to identify nodes having labels relevant to the document based on the document information, and the method further comprises:
an iterative process of causing the large language model to identify relevant child nodes of nodes previously identified as relevant, the iterative process continuing until leaf nodes of the taxonomy are reached; and
classifying the document into each of the labels associated with the leaf nodes of the taxonomy identified as relevant.

7. The method of claim 1, wherein the prompt causes the large language model to output a node for classifying the document if the label of the node is relevant to the document and a label of the node's parent node is relevant to the document.

8. The method of claim 1, wherein the prompt causes the large language model to:
determine a relevancy score for each node of the taxonomy based on a similarity between the label of the node and the document information;
rank the leaf nodes of the taxonomy based on the relevancy score of each leaf node; and
output a predetermined number of the highest-ranking leaf nodes.

9. The method of claim 8, wherein the prompt causes the large language model to rank the leaf nodes of the taxonomy based on the relevancy score of each leaf node and the relevancy score of the parent node of each leaf node.

10. The method of claim 8, wherein the prompt causes the large language model to rank the leaf nodes of the taxonomy based on the relevancy score of each leaf and the relevancy score of each ancestor node of each leaf node.

11. The method of claim 1, wherein the prompt causes the large language model to:
determine whether each leaf node of the taxonomy is relevant to the document based on the document information;
for each leaf node determined to be relevant, determine whether its parent node is relevant to the document based on the document information; and
output each leaf node for which the leaf node and its parent node are determined to be relevant to the document.

12. The method of claim 1, further comprising:
determining a first embedding of the document information;
determining a second embedding of the label of each node;
determining a cosine similarity between the first embedding of the document information and the second embedding of the label of each node;
removing each node from the taxonomy having a cosine similarity value lower than a predetermined threshold to determine a pruned taxonomy; and
inputting the pruned taxonomy and the document information into the large language model.

13. The method of claim 1, further comprising:
prompting the large language model to determine a predetermined number of the most relevant nodes output by the large language model for classifying the document; and
classifying the document into each of the determined most relevant nodes.

14. The method of claim 1, further comprising:
prompting the large language model to determine the most relevant node output by the large language model for classifying the document among sibling nodes having the same parent; and
classifying the document into the most relevant nodes among the sibling nodes.

15. A system for classifying a document into a hierarchical taxonomy associated with a corpus of documents, the document being associated with document information, the hierarchical taxonomy comprising a plurality of levels with each level comprising one or more nodes, each node comprising a label, the system comprising:
one or more processors; and
a non-transitory, processor-readable storage medium comprising one or more programming instructions stored thereon that, when executed, causes the one or more processors to:
input the taxonomy and the document information into a large language model;
input a prompt into the large language model to cause the large language model to output one or more nodes of the taxonomy for classifying the document based on the document information; and
classify the document into each of the nodes output by the large language model.

16. The system of claim 15, wherein:
the prompt causes the large language model to traverse top-level nodes of the taxonomy to identify nodes having labels relevant to the document based on the document information, and the programming instructions further cause the one or more processors to:
perform an iterative process of causing the large language model to identify relevant child nodes of nodes previously identified as relevant, the iterative process continuing until leaf nodes of the taxonomy are reached; and
classify the document into each of the labels associated with the leaf nodes of the taxonomy identified as relevant.

17. The system of claim 15, wherein the prompt causes the large language model to output a node for classifying the document if the label of the node is relevant to the document and a label of the node's parent node is relevant to the document.

18. The system of claim 15, wherein the prompt causes the large language model to:
determine a relevancy score for each node of the taxonomy based on a similarity between the label of the node and the document information;
rank the leaf nodes of the taxonomy based on the relevancy score of the nodes; and
output a predetermined number of the highest-ranking leaf nodes.

19. The system of claim 15, wherein the prompt causes the large language model to:
determine whether each leaf node of the taxonomy is relevant to the document based on the document information;
for each leaf node determined to be relevant, determine whether its parent node is relevant to the document based on the document information; and
output each leaf node for which the leaf node and its parent node are determined to be relevant to the document.

20. The system of claim 15, wherein the programming instructions further cause the one or more processors to:
determine a first embedding of the document information;
determine a second embedding of the label of each node;
determine a cosine similarity between the first embedding of the document information and the second embedding of the label of each node;
remove each node from the taxonomy having a cosine similarity value lower than a predetermined threshold to determine a pruned taxonomy; and
input the pruned taxonomy and the document information into the large language model.
